(19) United States
(12) Patent Application Publication
(10) Pub. No.: US 2026/0162564 A1
(43) Pub. Date: Jun. 11, 2026

(54) DISEASE-ASSOCIATED SCENTS AND USE OF THE SAME AS AN EDUCATIONAL TOOL

(71) Applicant: Arizona Board of Regents on Behalf of the University of Arizona, Tucson, AZ (US)

(72) Inventor: Ryane ENGLAR, Oro Valley, AZ (US)

(21) Appl. No.: 19/410,718

(22) Filed: Dec. 5, 2025

Related U.S. Application Data
(60) Provisional application No. 63/730,897, filed on Dec. 11, 2024.

(51) Int. Cl. G09B 23/30

(52) U.S. Cl. CPC G09B 23/30

(57) ABSTRACT

Provided herein are educational models for olfactory detection (or observation) and identification of a disease or condition of a patient, or body part or secretion thereof.

### CROSS REFERENCE TO RELATED APPLICATION

This application claims the benefit of U.S. Provisional Application No. 63/730,897 filed on Dec. 11, 2024, the entire contents of which are incorporated by reference herein.

### FIELD OF THE INVENTION

The present disclosure generally relates the preparation and use of natural, artificial, or synthetic, compounds that emit a scent (or smell) that resembles the scent of a patient's disease or condition of a body part of the patient or of a bodily emission from the patient.

### BACKGROUND

Clinical reasoning drives health care delivery and affects patient outcomes by influencing diagnostic and treatment planning. In order to make informed decisions that reflect contextualized care, providers must gather patient-specific data from a variety of sources. History taking and physical examination disclose patient-specific findings that contribute to diagnostic accuracy by guiding next steps in the diagnostic process. One source of patient-specific findings that may be obtained during a physical examination of a patient or during clinical evaluation of a patient's biofluids and other bodily emissions (e.g., saliva, mucus, bile, breath condensate, sweat, vomitus, vaginal secretions, semen, urine, tears, desquamation of the skin [i.e., skin peeling and other dander], blood, breastmilk, feces, and so on) is olfactory information, or odor, emitted by said secretions. Unfortunately, current clinical skills laboratories often lack the integration of olfactory cues into hands-on training, relying almost exclusively on visual and tactile simulators.

### SUMMARY OF THE DISCLOSURE

Various aspects of the present disclosure are directed to the preparation and use of natural, artificial, or synthetic, compounds that emit a scent (or smell or odor) that resembles the scent of a patient's disease or clinical condition. Various non-limiting inventive aspects according to the disclosure are as described herein.

In some instances, a first aspect of the disclosure can be described as an educational model comprising a plurality of numbered containers, where each numbered container contains one or more compositions exhibiting a scent corresponding to a scent of a disease or condition of a patient, and an answer key or guide, where the answer key or guide provides an identification of each of the one or more compositions in each of the plurality of numbered containers.

In some instances, a second aspect of the disclosure can be described as an educational model according to the first aspect, wherein the answer key or guide further identifies disease(s) or condition(s) having a scent, smell or odor resembling that of each of the one or more compositions in the numbered containers.

In some instances, a third aspect of the disclosure can be described as an educational model according to the first or second aspect, wherein the answer key or guide further identifies location(s) or body part(s) where a practitioner would detect a scent, smell or odor resembling that of the one or more compositions in the numbered containers.

In some instances, a fourth aspect of the disclosure can be described as an educational model according to the first through third aspects, wherein the answer key or guide further identifies type(s) of secretion(s) having a scent, smell or odor resembling that of the one or more compositions in the numbered containers.

In some instances, a fifth aspect of the disclosure can be described as an educational model according to the first through fourth aspects, wherein the one or more compositions in at least one of the plurality of numbered containers are diluted in a diluent.

In some instances, a sixth aspect of the disclosure can be described as an educational model according to the first through fourth aspects, wherein the one or more compositions in at least one of the plurality of numbered containers are dispersed in an oil-water emulsion or a water-in-oil emulsion.

In some instances, a seventh aspect of the disclosure can be described as an educational model according to the first through fourth aspects, wherein the one or more compositions in at least one of the plurality of numbered containers are dispersed in a gel.

In some instances, an eighth aspect of the disclosure can be described as an educational model according to the first through fourth aspects, wherein the one or more compositions in at least one of the plurality of numbered containers are dispersed in a solid absorbent.

In some instances, a ninth aspect of the disclosure can be described as an educational model according to the first through eighth aspects, wherein the one or more compositions comprise thiols, ketones, and/or amines.

In some instances, a tenth aspect of the disclosure can be described as an educational model comprising a plurality of numbered substrates, where each numbered substrate has one or more compositions, exhibiting a scent corresponding to a scent of a disease or condition of a patient, disposed on a surface thereof, and an answer key or guide, where the answer key or guide provides an identification of each of the one or more compositions disposed on each of the plurality of numbered substrates.

In some instances, an eleventh aspect of the disclosure can be described as an educational model according to the tenth aspect, wherein the answer key or guide further identifies disease(s) or condition(s) having a scent, smell or odor resembling that of each of the one or more compositions disposed on each of the plurality of numbered substrates.

In some instances, a twelfth aspect of the disclosure can be described as an educational model according to the tenth or eleventh aspect, wherein the answer key or guide further identifies location(s) or body part(s) where a practitioner would detect a scent, smell or odor resembling that of the one or more compositions on each of the plurality of numbered substrates

In some instances, a thirteenth aspect of the disclosure can be described as an educational model according to any one of the tenth through twelfth aspects, wherein the answer key or guide further identifies type(s) of secretion(s) having a scent, smell or odor resembling that of the one or more compositions on each of the plurality of numbered substrates.

In some instances, a fourteenth aspect of the disclosure can be described as an educational model according to any one of the tenth through thirteenth aspects, wherein each of the plurality of substrates comprise an adhesive, the adhesive located on a side of the substrate opposite the one or more compositions.

In some instances, a fifteenth aspect of the disclosure can be described as an educational model according to the fourteenth aspect, further comprising a manikin onto which the plurality of numbered substrates are configured to be reversibly adhered with the adhesive.

In some instances, a sixteenth aspect of the disclosure can be described as an educational model according to any one of the tenth through fifteenth aspects, wherein the one or more compositions of at least one of the plurality of numbered substrates are dispersed in a gel.

In some instances, a seventeenth aspect of the disclosure can be described as an educational model according to any one of the tenth through fifteenth aspects, wherein the one or more compositions of at least one of the plurality of numbered substrates are contained in a microencapsulant.

In some instances, an eighteenth aspect of the disclosure can be described as an educational model according to any one of the tenth through fifteenth aspects, wherein the one or more compositions in at least one of the plurality of numbered substrates are dispersed in a solid absorbent.

In some instances, a nineteenth aspect of the disclosure can be described as an educational model according to any one of the tenth through eighteenth aspects, wherein the one or more compositions comprise thiols, ketones, and/or amines.

In some instances, a twentieth aspect of the disclosure can be described as an educational model comprising a plurality of compositions, each composition exhibiting a scent corresponding to a scent of a disease or condition of a patient; a manikin comprising a plurality of air permeable pouches or chambers, each pouch or chamber configured to allow for placement of one or more of the plurality of compositions therein; and an answer key or guide, the answer key or guide providing an identification of each of the one or more compositions and zones of the manikin for placement of the plurality of compositions in the plurality of air permeable pouches or chambers.

In some instances, a twenty-first aspect of the disclosure can be described as an educational model according to the twentieth aspect, wherein the answer key or guide further identifies disease(s) or condition(s) having a scent, smell or odor resembling that of each of the plurality of compositions.

In some instances, a twenty-second aspect of the disclosure can be described as an educational model according to the twentieth or twenty-first aspect, wherein the answer key or guide further identifies type(s) of secretion(s) having a scent, smell or odor resembling that of each of the plurality of compositions.

In some instances, a twenty-third aspect of the disclosure can be described as an educational model according to any one of the twentieth through twenty-second aspects, wherein at least one of the plurality of compositions are dispersed in a gel.

In some instances, a twenty-fourth aspect of the disclosure can be described as an educational model according to any one of the twentieth through twenty-second aspects, wherein at least one of the plurality of compositions are dispersed in a solid absorbent.

In some instances, a twenty-fifth aspect of the disclosure can be described as an educational model according to any one of the twentieth through twenty-fourth aspects, wherein the one or more compositions comprise thiols, ketones, and/or amines.

### DETAILED DESCRIPTION

The following description of the instances is merely exemplary in nature and is in no way intended to limit the subject matter of the present disclosure, their application, or uses.

As used throughout, ranges are used as shorthand for describing each and every value that is within the range. Any value within the range can be selected as the terminus of the range. Unless otherwise specified, all percentages and amounts expressed herein and elsewhere in the specification should be understood to refer to percentages by weight.

For the purposes of this specification and appended claims, unless otherwise indicated, all numbers expressing quantities, percentages or proportions, and other numerical values used in the specification and claims, are to be understood as being modified in all instances by the term “about.” The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent, alternatively ±5 percent, alternatively ±1 percent, alternatively ±0.5 percent, and alternatively ±0.1 percent of the given numeric value provided such a deviation does not alter the end function or result of the value. Accordingly, unless indicated to the contrary, the numerical parameters set forth in this specification and attached claims are approximations that can vary depending upon the desired properties sought to be obtained by the present invention.

It is noted that, as used in this specification and the appended claims, the singular forms “a,” “an,” and “the,” include plural references unless expressly and unequivocally limited to one referent. As used herein, the term “include” and its grammatical variants are intended to be non-limiting, such that recitation of items in a list is not to the exclusion of other like items that can be substituted or added to the listed items. For example, as used in this specification and the following claims, the terms “comprise” (as well as forms, derivatives, or variations thereof, such as “comprising” and “comprises”), “include” (as well as forms, derivatives, or variations thereof, such as “including” and “includes”) and “has” (as well as forms, derivatives, or variations thereof, such as “having” and “have”) are inclusive (i.e., open-ended) and do not exclude additional elements or steps. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

Furthermore, “and/or” where used herein is to be taken as specific disclosure of each of the two specified features or components with or without the other. Thus, the term “and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following aspects: A, B, and C; A, B, or C; A or C; A or B; B or C; A and C; A and B; B and C; A (alone); B (alone); and C (alone).

As used herein, the term “secretion” means a body substance in a liquid or semisolid state produced by an exocrine gland. The term “secretion”, as used herein, also is synonymous with “bodily emission”, meaning an endogenous substance produced through the activity of cells or glands, tissues or organs.

As used herein, the term “practitioner” is defined as any healthcare professional that evaluates and/or clinically manages a human or non-human animal for a disease or medical condition and includes both medical and veterinary healthcare professionals.

As used herein, the term “patient” means any human or non-human animal that a practitioner may evaluate and/or clinically manage for a disease or non-disease related medical condition.

Body odors can be thought of as olfactory “fingerprints” that communicate health status to others. Each characteristic scent of disease stems from emission of key volatile and semi-volatile organic compounds (VOCs) in breath, sweat, urine, skin, blood, milk, feces, and/or other secretions. To date, over 1800 VOCs have been identified as exhibited by humans for comparison between healthy and diseased (or non-disease related medical conditions) patients. Analytical methods, such as gas chromatography, mass spectrometry, breath analyzers and other olfactometers, have paved the way for identification of VOCs in diseased human patients. Advances in technology have also led to the development of so-called ‘electronic noses’ to analyze samples for VOCs in research settings. However, there is an appreciable gap in the current medical and veterinary literature in this growing field of research. Current publications fail to describe how to utilize characteristic odors in a way that they can be incorporated in training general practitioners to recognize disease-specific scents. The use of scents as a diagnostic and educational tool as described herein will serve as an effective component in the design of clinical skills curricula in a wide variety of medical and veterinary applications. Practitioners-in-training (e.g., medical and veterinary students, nurses and veterinary technicians) often comment that clinical skills laboratories lack realism and therefore fall short of replicating real-world clinical casework. The ability to simulate abnormal findings would provide consistency and reproducibility by allowing instructors to recreate common clinical presentations that learners can then investigate using appropriate methodologies for clinical case management. Simulation in this respect provides guided experiences that replicate real-world olfactory observations experienced by a practitioner, and promotes pattern recognition, competence, confidence, and clinical acumen.

In accordance with various aspects of the disclosure, various diseases or conditions can be identified, at least in part, based upon the scent emitted by a patient, or body part or secretion thereof. Exemplary diseases or conditions include, but are not limited to, bacterial vaginitis (commonly described as a “fishy” smell), cholera (commonly described as a sweet “rice-water” scent of cholera-associated diarrhea), ketosis and diabetic ketoacidosis (commonly described as a ketone, such as acetone, scent), diphtheria (commonly described as a sickening sweet or “putrid” scent of a patient's breath), gas gangrene, hepatic encephalopathy (commonly described as a “musty” smell), ileus (commonly described as a fecal odor of a patient's breath), Pseudomonas aeruginosa wound infections (commonly described as a “fruity” scent), liver failure (commonly described as a “sulfur” scent), maple syrup urine disease (MSUD; commonly described as a “caramel” or “malty” scent), kidney failure (commonly described as a uremic scent of a patient's breath), methionine malabsorption syndrome (commonly described as a “yeast” or “malt-like” odor of a patient's urine), necrotic and ulcerated tissues (commonly described as a putrid smell), phenylketonuria (commonly described as a “sweaty locker room towel” odor), rotaviral and Clostridium difficile diarrhea, scarlet fever (and the associated scent of a patient's breath), trimethylaminuria (commonly described as “fish odor disease” smell); typhoid fever (commonly described as a “musty” or “baked-bread” smell, yellow fever (commonly described as “butcher's shop” odor), Malassezia yeast overgrowth, periodontal disease, and Pseudomonas -induced otitis externa, canine parvoviral enteritis, and Western diamond rattlesnake bite wounds (commonly described as having a “maple syrup” smell).

Various aspects of the disclosure are directed to compositions that emit a characteristic scent, smell or odor that corresponds to the scent, smell or odor indicative of a disease(s) and/or condition(s), and the use of such compositions as educational tools. Compositions according to various aspects of the disclosure may take various forms.

In some instances, compositions according to the disclosure can be used in their current form without or substantially without further modification. For example, in instances where the disease or condition to be identified exhibits a scent of a common household or pre-prepared item such as maple syrup or caramel (such as Western diamond rattlesnake bites or MSUD), compositions according to the disclosure may consist of or consist essentially of a compound such a maple syrup or caramel as is or diluted in water.

In some instances, compositions according to the disclosure can comprise a compound, exhibiting a specific scent, smell or odor, dissolved in a biocompatible diluent. For example, in instances where a disease or condition to be identified exhibits a “fishy” smell (for example, periodontal disease, bacterial vaginitis, and trimethylaminuria) an appropriate amine compound such a trimethylamine may be diluted in a diluent such as food grade propylene glycol. Also, when a disease or condition to be identified exhibits a ketone smell (for example, ketosis and diabetic ketoacidosis) an appropriate ketone compound such as acetone may be diluted in a diluent such as food grade propylene glycol. Also, when a disease or condition to be identified exhibits a sulfur smell (for example, liver failure) an appropriate thiol compound may be diluted in a diluent.

In some instances, compositions according to the disclosure can comprise a compound exhibiting a specific scent, smell or odor, dispersed in an oil-in-water or water-in-oil emulsion. In such instances, the choice of emulsion type may be predicated on the solubility of the compound(s) exhibiting the specific scent, smell or odor in an oil phase or an aqueous phase.

In some instances, compositions according to the disclosure can comprise a compound, exhibiting a specific scent, smell or odor, dispersed in a gel or other semisolid.

In some instances, compositions according to the disclosure can comprise a compound, exhibiting a specific scent, smell or odor, dispersed in a solid absorbent such as porous silicates or aluminosilicates or polymeric beads.

Compositions as described herein can be integrated into pre-clinical medical and veterinary school curricula in alignment with core coursework that teaches foundational knowledge in anatomy, physiology, pathology, and pathophysiology. Transitioning from didactic instructional methods to hands-on experiential learning will increase student confidence and diagnostic accuracy with respect to olfactory detection of scents, smells or odors associated with disease(s) and clinical condition(s) of a patient. Compounds according to the disclosure may be implemented in various ways as education tools. In some instances, compounds according to the disclosure may be provided in a series of containers, which may be used directly as educational tools. In such instances, each container may be numbered and contain a compound that emits a scent associated with one or more diseases and/or clinical conditions. A key or guide providing a detailing of the contents of each numbered container is also provided as part of the educational tool. In some instances, a plurality of compounds may be incorporated into kits for use as educational models.

In accordance with various aspects of the disclosure, educational models in the form of kits for the olfactory detection (or observation) and identification of a disease or clinical condition of a patient, or body part or secretion thereof is provided. Kits according to various aspects of the disclosure may take various forms.

For example, a kit according to various aspects of the disclosure may include a plurality of numbered containers (such as Petri dishes or glass tubes), each containing one or more compositions that have a scent, smell or odor corresponding to the scent, smell or odor of a disease or clinical condition. The kit may further include an instructor key or guide that tells the instructor the contents of each numbered container and one or more of a) the disease(s) or clinical condition(s) commonly having a scent, smell or odor resembling that of one or more compositions in the numbered container, b) the location(s) or body part(s) where a practitioner would commonly detect a scent, smell or odor resembling that of one or more compositions in the numbered container; and/or c) the type(s) of secretion(s) where a practitioner would commonly detect a scent, smell or odor resembling that of one or more compositions in the numbered container.

Also, for example, a kit according to various aspects of the disclosure may include a plurality of individually numbered substrates, each substrate having one or more compositions that have a scent, smell or odor (corresponding to the scent, smell or odor of a disease or clinical condition) disposed on a surface of the substrate. The type of substrate that may be used is not particularly limited. In some instances, the substrates may be made of a textile, plastic or glass that is sufficiently sturdy and resilient to allow for multiple reuses of the kit. The mode by which the one or more compositions that have a scent, smell or odor are disposed on a surface of a substrate, according to various aspect of the disclosure, is not particularly limited. In some instances, each of the plurality of individually numbered substrates are in the form of “scratch-and-sniff” substrates, where each substrate comprises one or more distinct zones, each of the distinct zones bounding a distinct one or more compositions that emit a scent, smell or odor to be “sniffed” in response to “scratching” the zone. As one of ordinary skill in the art may appreciate, there are various methods of forming scratch-and-sniff materials, including microencapsulation of a composition in an encapsulant that is configured to break of burst in response to application of force thereon (e.g., scratching), thus providing a path for emission of the one or more compositions into the external environment for olfactory detection. The kit may further include an instructor key or guide that tells the instructor the contents of each numbered substrate and each distinct zone of said substrate (if more than one distinct zone is present), and one or more of a) the disease(s) or clinical condition(s) commonly having a scent, smell or odor resembling that of one or more compositions disposed on the numbered substrate (and each distinct zone), b) the location(s) or body part(s) where a practitioner would commonly detect a scent, smell or odor resembling that of one or more compositions disposed on the numbered substrate (and each distinct zone); and/or c) the type(s) of secretion(s) that a practitioner would commonly associate with a scent, smell or odor resembling that of one or more compositions disposed on the numbered container substrate (and each distinct zone).

In some instances, each individually numbered substrate may further comprise an adhesive on a side of substrate opposite that of the side having the one or more compositions disposed thereon, to allow for reversible placement and adherence of the substrate on a portion of a manikin or other form of artificial patient or portion thereof. Such a kit configuration would be especially targeted for training practitioners to visually associate a scent, smell or odor of a disease or clinical condition with a particular region of a patient. In such instances, a corresponding kit may further include an instructor key or guide that tells the instructor the contents of each composition, the diseases or conditions corresponding to each composition and zones of a patient's body where each substrate may be placed on the manikin based upon the disease or condition.

Also, for example, a kit according to various aspects of the disclosure may include a plurality of compositions that have a scent, smell or odor (corresponding to the scent, smell or odor of a disease or condition) and a manikin. The manikin comprises a plurality of pouches or chambers. Each pouch or chamber is integrated in different zones of the manikin (for example, locations of the manikin corresponding to a patient's mouth, ears, scalp, appendages, groin, and so on). Each pouch is configured to allow for placement of a composition (that has a scent, smell or odor) therein and each pouch is air permeable to allow for the scent of the compositions to diffuse into the environment external to the manikin to allow for olfactory detection by a practitioner of practitioner-in-training. The kit may further include an instructor key or guide that tells the instructor the contents of each composition, the diseases or clinical conditions corresponding to each composition and zones of a patient's body where each composition may be placed in the manikin based upon the disease or condition, and/or the types of secretions having a scent, smell or odor resembling that of each of the compositions. Kits such as described in this example provide an instructor with the liberty to prepare individualized and targeted olfactory detection training modules for practitioners and practitioners-in-training.

While certain implementations have been described in terms of what may be considered to be specific aspects, the present disclosure is not limited to the disclosed aspects. Additional modifications and improvements to the aforementioned synthetic scents and the approaches by which they are incorporated into instructional and assessment phases of curricula may be apparent to those skilled in the art. Moreover, the many features and advantages of the disclosure are apparent from the detailed specification, and thus, it is intended by the appended claims to cover all such features and advantages of the present disclosure which fall within the spirit and scope of the disclosure.

What is claimed is:

1. An educational model comprising:
a plurality of numbered containers, each numbered container containing one or more compositions exhibiting a scent corresponding to a scent of a disease or condition of a patient; and
an answer key or guide, the answer key or guide providing an identification of each of the one or more compositions in each of the plurality of numbered containers.

2. The educational model of claim 1, wherein the answer key or guide further identifies one or more of:
disease(s) or condition(s) having a scent, smell or odor resembling that of each of the one or more compositions in the numbered containers;
location(s) or body part(s) where a practitioner would detect a scent, smell or odor resembling that of the one or more compositions in the numbered containers; and
type(s) of secretion(s) having a scent, smell or odor resembling that of the one or more compositions in the numbered containers.

3. The educational model of claim 1, wherein the one or more compositions in at least one of the plurality of numbered containers are diluted in a diluent.

4. The educational model of claim 1, wherein the one or more compositions in at least one of the plurality of numbered containers are dispersed in an oil-water emulsion or a water-in-oil emulsion.

5. The educational model of claim 1, wherein the one or more compositions in at least one of the plurality of numbered containers are dispersed in a gel.

6. The educational model of claim 1, wherein the one or more compositions in at least one of the plurality of numbered containers are dispersed in a solid absorbent.

7. The educational model of claim 1, wherein the one or more compositions comprise thiols, ketones, and/or amines.

8. An educational model comprising:
a plurality of numbered substrates, each numbered substrate having one or more compositions, exhibiting a scent corresponding to a scent of a disease or condition of a patient, disposed on a surface thereof; and
an answer key or guide, the answer key or guide providing an identification of each of the one or more compositions disposed on each of the plurality of numbered substrates.

9. The educational model of claim 8, wherein the answer key or guide further identifies one or more of:
disease(s) or condition(s) having a scent, smell or odor resembling that of each of the one or more compositions disposed on each of the plurality of numbered substrates;
location(s) or body part(s) where a practitioner would detect a scent, smell or odor resembling that of the one or more compositions on each of the plurality of numbered substrates; and
type(s) of secretion(s) having a scent, smell or odor resembling that of the one or more compositions on each of the plurality of numbered substrates.

10. The educational model of claim 8, wherein each of the plurality of substrates comprise an adhesive, the adhesive located on a side of the substrate opposite the one or more compositions.

11. The educational model of claim 8, further comprising a manikin onto which the plurality of numbered substrates are configured to be reversibly adhered with the adhesive.

12. The educational model of claim 8, wherein the one or more compositions of at least one of the plurality of numbered substrates are dispersed in a gel.

13. The educational model of claim 8, wherein the one or more compositions in at least one of the plurality of numbered substrates are contained in a microencapsulant.

14. The educational model of claim 8, wherein the one or more compositions in at least one of the plurality of numbered substrates are dispersed in a solid absorbent.

15. The educational model of claim 8, wherein the one or more compositions comprise thiols, ketones, and/or amines.

16. An educational model comprising:
a plurality of compositions, each composition exhibiting a scent corresponding to a scent of a disease or condition of a patient;
a manikin comprising a plurality of air permeable pouches or chambers, each pouch or chamber configured to allow for placement of one or more of the plurality of compositions therein; and
an answer key or guide, the answer key or guide providing an identification of each of the one or more compositions and zones of the manikin for placement of the plurality of compositions in the plurality of air permeable pouches or chambers.

17. The educational model of claim 16, wherein the answer key or guide further identifies one or both of:
disease(s) or condition(s) having a scent, smell or odor resembling that of each of the plurality of compositions; and
type(s) of secretion(s) having a scent, smell or odor resembling that of each of the plurality of compositions.

18. The educational model of claim 1, wherein at least one of the plurality of compositions are dispersed in a gel.

19. The educational model of claim 1, wherein at least one of the plurality of compositions are dispersed in a solid absorbent.

20. The educational model of claim 1, wherein the one or more compositions comprise thiols, ketones, and/or amines.
